(19) United States
(12) Patent Application Publication
(10) Pub. No.: US 2020/0186378 A1
(43) Pub. Date: Jun. 11, 2020

(54) SMART HUB SYSTEM

(71) Applicants: CURTIS WAYNE SIX, BRADENTON, FL (US); JUSTIN C MONGER, ROCKWALL, TX (US)

(72) Inventors: CURTIS WAYNE SIX, BRADENTON, FL (US); JUSTIN C MONGER, ROCKWALL, TX (US)

(21) Appl. No.: 16/614,965

(22) PCT Filed: May 21, 2018
(86) PCT No.: PCT/US18/33741

§ 371 Date: Nov. 19, 2019

Related U.S. Application Data
(60) Provisional application No. 62/646,362, filed on Mar. 21, 2018.
(60) Provisional application No. 62/508,528, filed on May 19, 2017.

(51) Int. Cl. H04L 12/28; H04L 12/24; G06F 3/0481; G06F 3/0486; G06F 3/0484

(52) U.S. Cl. CPC H04L 12/283; H04L 41/12; H04L 41/22; H04W 84/18; G06F 3/0486; G06F 3/04847; G06F 3/04817

(57) ABSTRACT

A secure smart hub system for integrating and controlling multiple networked devices such as home automation devices and providing a platform for accessing cloud based services includes voice authentication and identification means and other core functionality that is available without an active internet connection. The system includes a smart hub instigated voice prompt function responsive to behavior patterns of a monitored subject when reconciled with rules data as interpreted by a cloud based AI analysis engine. The system provides continuous monitoring of WAN and LAN connectivity and provides reporting and alerts on performance metrics. The system connects through a default secure VPN connection. The system further includes location-aware portable computing devices and a flexible, configurable and intuitive interface for both users and administrators.

### FIELD

The invention relates generally to controllers for integrating control over multiple home automation devices and systems and more specifically to an internet outage secure smart hub system that includes an intuitive user interface, AI assistance and continuous system monitoring for user control and administration of various devices and services.

### BACKGROUND

So-called “smart hubs” are hardware devices that typically connect to a user's home WiFi connection/router and allow integration of multiple home automation devices for centralized control of the various home automation devices devices. Smart hubs typically include a software application interface; often a smartphone application. More recently, some smart hubs have included a listening function that may interface not only with the various connected home automation devices, but cloud based services as well. Some smart hubs include a “virtual smart assistant” such as the Amazon Echo® which employs Alexa® for voice recognition and voice controlled automation.

Because current smart hubs rely heavily on cloud based services—especially for authentication and authorization of authorized users permitted to control the various home automation devices, one persistent problem has been vulnerability to ISP network downtime. If an ISP connection is dropped, many or all devices dependent on the smart hub will fail to work.

This failure may manifest itself in a temporary failure of a non-critical function, or in worst cases, a critical failure and/or a complete user lockout of device functionality.

Due to cloud based dependencies, concerns have also been raised regarding possible remote hacking of smart hubs. As more home automation devices are integrated into cloud based home automation services, risks of cyber attack and negative consequences resulting from malicious hacking have increased.

Generally, despite advantages gained by centralizing home automation functions, smart hub interfaces tend to require a steep learning curve simply to administratively add, control or troubleshoot connected devices.

Another disadvantage of past smart hubs is uneven support of various connection protocols employed by vendors of home automation devices. Adoption of home automation products and services may even be hindered by proprietary or poorly documented communications protocols in an attempt at vendor lock in.

Yet another disadvantage of past smart hub systems is that they do not lend themselves readily to personal healthcare applications.

Accordingly, it would be desirable for a smart hub system to provide a universal communications layer for supporting the disparate communications protocols (e.g., RS-485, 6LoWPAN, Z-Wave, ZigBee, Bluetooth LE, X10, Ethernet) of various home automation devices, and at least provide support for the following products/vendors: Amazon Echo@, Hue, Lutron, and WeMo®.

Further, it would be desirable for such a smart hub system to include a location-aware user interfacing means such as GPS enabled tablet computing devices that enable two-way tablet to tablet and tablet to user communications and user to tablet commands and thereby permit operation and administration of the various connected home automation devices in the system.

Further, it would be desirable for such a smart hub system to include core functionality including control of home automation connected devices that may be locally accessed, locally monitored and wherein core device functionality is maintained even in the absence of an active internet connection.

Further, it would be desirable for such a smart hub system to possess the capability for local, i.e., internet independent, authentication and authorization functionality.

Further, it would be desirable for such a smart hub system to include multiple levels of control whereby under certain conditions, core device settings may be accessed with proper permissions, with or without an active internet connection or wired network.

Further, it would be desirable for such a smart hub system to include voice identification functionality for identifying users and assigning permissions accordingly.

Further, it would be desirable for such a smart hub system to provide default a Virtual Private Network “VPN” connection to ensure privacy and enhanced security against cyber attacks or hacking.

Further, it would be desirable for such a smart hub system to include LAN and WAN monitoring and reporting functionality.

Further, it would be desirable for such a smart hub system to include location-aware portable computing components/devices such as Bluetooth® Beacons that may communicate location information with the smart hub component directly, or with each other.

In the summary section that follows, the term “system” indicates one or more devices and/or one or more wireless communication interfaces. The term “device” means a hardware component of the foregoing system that may include an OEM software component, a custom software component, and which may also include one or more inter-device communication protocols, administrative interfaces, user interfaces, or the like. Furthermore, although the instant invention is directed to the centralized control of home automation devices, it is intended that other electronic devices—not solely those customarily understood as home automation devices, may be integrated with

the system without departing from the intended invention.

### SUMMARY

In a general implementation according to the present disclosure, a voice actuated and voice controllable system for integrating the administrative control of multiple home/office automation systems, general purpose devices or personal healthcare devices includes at least a smart hub component and at least one portable computing component such as at least one tablet computing device capable of interfacing with the smart hub component and wherein the at least one portable computing component is capable of communicating with another portable computing component and with a user directly by voice command and/or touch command.

In an aspect combinable with the foregoing exemplary implementation, the voice actuated and voice controllable system includes one or more software components with one or more client based voice recognition modules or cloud based voice recognition modules.

In an aspect combinable with the foregoing exemplary implementation, the voice actuated and voice controllable system includes one or more software components that include one or more graphical user interfaces.

In an aspect combinable with the foregoing exemplary implementation, the voice actuated and voice controllable system includes voice identification functionality that permits the system to differentiate between multiple users for purposes of determining user permissions.

In an aspect combinable with the foregoing exemplary implementation, the portable computing components of the system include local speech-to-text functionality.

In an aspect combinable with the foregoing exemplary implementation, the portable 115 computing components of the system include a user interface and/or administrator interface that includes drag and drop functionality, and other functions enabling a user to create or designate an icon, a symbol or any indicia which may be graphical or textual, for visually representing or providing touch screen access to a device or user-defined command.

In an aspect combinable with the foregoing exemplary implementation, the tablet computing components of the system include a user interface and/or administrator interface that includes a “home” screen interface and customization interfaces that are intuitively navigatable.

In an aspect combinable with the foregoing exemplary implementation, the tablet computing components include a user interface and/or administrator interface that includes home automation devices and cloud/web based services graphically represented by icons, symbols or other indicia, and/or user-defined commands/actions represented by icons, symbols or other indicia.

In an aspect combinable with the foregoing exemplary implementation, the tablet computing components include a user interface and/or administrator interface that includes devices graphically represented by icons, symbols or other indicia, and/or user commands/actions represented by icons, symbols or other indicia, wherein each icon, symbol or other indicia may be linked to a corresponding user-defined voice command for accessing the represented device or command.

In an aspect combinable with the foregoing exemplary implementation, the tablet computing components include a user interface and/or administrator interface that includes scene creation functionality which is a visual representation of a scene comprised of grouped devices and/or user commands that are added to the scene typically by drag and drop actions, and wherein the scene is identified by location or any other user categorization.

In an aspect combinable with the foregoing exemplary implementation, during a user interaction with at least one tablet computing component, other tablet computing components may designate a primary tablet for active listening mode for user command execution, and place other networked tablets in passive listening mode. A primary tablet in listening mode may communicate with other tablets in passive mode.

In an aspect combinable with the foregoing exemplary implementation, connected devices of the system further include a WiFi connection means, and a power source.

In an aspect combinable with any of the previous aspects, any connected home automation device or sensor may operate in infrastructure or ad hoc mode.

In an aspect combinable with any of the previous aspects, the system may include at least the following wireless communications means; e.g., GSM, CDMA, 4G, LTE or Bluetooth®.

In an aspect combinable with any of the previous aspects, the smart hub component may wirelessly connect to a computing device such as a smartphone or other computing device (e.g., laptop computer).

In an aspect combinable with any of the previous aspects the tablet computing components may be location aware.

In an aspect combinable with any of the previous aspects, the smart hub component may log and “remember” a WiFi or Bluetooth® enabled device or network.

In an aspect combinable with any of the previous aspects, the system may include at least one local software component that communicates with a cloud computing environment 160 for purposes of device discovery and/or controlling access to one or more home automation devices or sensors.

In an aspect combinable with any of the previous aspects, the tablet computing components may include a listening mode which may be passive, active, intermittent or always on.

In an aspect combinable with any of the previous aspects, the system may include at least one software component that is connected to a cloud computing environment which enables multi-level access control of the various connected home automation devices, may establish a time window for permitting control of the connected home automation devices, and, may enable an authorized user to transmit invitations to guest users for conditional control over one or more connected systems or devices. Further, such invitations may include login credentials that may automatically enable guest permissions, or whatever permissions are pre-designated by the authorized user.

In an aspect combinable with any of the previous aspects, the system may include one or more local or cloud based database modules configured to store data in an encrypted format, such as user id(s), user password(s), owner id, administrator id, administrator password, MAC addresses for the home automation devices, configuration data for home automation devices and sensors, GPS coordinates, time or date ranges for device access, access, time in/time out time stamps and various metrics/data logging related to the operational status of any connected home automation device.

In an aspect combinable with any of the previous aspects, the system may receive passwords or digital keys and store the password or digital keys in encrypted or hashed format.

In an aspect combinable with any of the previous aspects, the system may include a local voice recognition and authorization function that includes ambient noise canceling/filtering functionality.

In an aspect combinable with any of the previous aspects, the smart hub of the system may include a module for the aggregating and reporting of sensor derived data. Connected sensors which may be user worn devices may provide among other metrics, user health metrics such as temperature or heart rate, visual or audio confirmation of user location, indoor temperature, indoor humidity, moisture detection and ambient sound levels.

In an aspect combinable with any of the previous aspects, the user interface or administrative interface includes a rules input screen wherein the user-defined rules, limits and ranges for (1) biometric results of a monitored subject obtained by the various devices, and (2) a hierarchy of responses based on the biometric results, are processed by a AI analysis engine that constantly learns to improve its responses by reconciling data regarding user routine and life patterns to modify the prompt behavior of the AI component of the smart hub system.

In an aspect combinable with any of the previous aspects, the administrative interface for the smart hub component may include a smart phone application and provide fail safe access to home automation device operation in case of power outage, network outage, password failure or telecommunications/phone outage, for example, by storing voice profile metrics locally on the smart phone or by pass code access.

In an aspect combinable with any of the previous aspects, the smart hub component and/or the tablet computing components may include an audible or silent alarm.

In an aspect combinable with any of the previous aspects, the smart hub component and/or the tablet computing components may include a motion sensor.

In an aspect combinable with any of the previous aspects, the smart hub component and/or tablet computing components may include an automatic shutdown mode and low battery mode.

In an aspect combinable with any of the previous aspects, the smart hub component and/or tablet computing components may include a battery backup.

In an aspect combinable with any of the previous aspects, the smart hub component and/or connected tablet computing components may include a camera for remote; e.g., wireless network monitoring of a property or an inhabitant of a property.

In an aspect combinable with any of the previous aspects, a video monitoring function of the smart hub includes a default real time privacy filter that will blur areas of the body that a user does not wished to be exposed.

In an aspect combinable with any of the previous aspects, the smart hub component and/or connected tablet computing components of the system may include an attaching component for physically anchoring or physically tethering the component(s) to a surface.

In an aspect combinable with any of the previous aspects, the smart hub component and/or tablet computing components may include brackets or fixtures configured for incorporation of the component(s) into an interior or exterior wall, a cabinet, a vehicle, an appliance.

In an aspect combinable with any of the previous aspects, the smart hub component and/or tablet computing components provide with an active internet connection, voice over IP (VOIP) functionality.

In an aspect combinable with any of the previous aspects, VOIP functionality may include speech-to-text functionality through a leveraged third party API.

The particular architecture of the instant system makes it an ideal property management tool. Objects and features of the smart hub system include physical condition reporting obtained from sensors, e.g., indoor and outdoor temperature, humidity, sound, power failures, smoke detection, door/window lock integrity, air quality, and pool temperature. In an aspect combinable with any of the previous aspects, the system may be employed as a means of communication such as a two-way portal between a tenant and a property owner, or property management company. Because the system is normally connected to an intranet or the internet, it is possible that ads and other reminders and notifications may be placed to run coincident with tenant occupancy. The ads, notifications and reminders may be delivered interactively, and comprise graphics, video or audio features. For example, when a tenant enters his/her apartment, the Peebo avatar 308 pane may inform the tenant that they have a package waiting at the front desk of the apartment. The tenant may ask the Peebo avatar the time of the next exercise class, the next trash pickup or the local weather forecast. Types of administrative notifications sent to the tenant through the avatar pane 308 may include, but are not limited to: Move-in Notifications, e.g., welcome packages, house rules, hours, points of contact, Reminders—Verbal and/or Graphic; e.g., trash pick up day, delivered packages, maintenance activity, rent payment due, Apartment and Neighborhood Activity, e.g., event schedules, exercise classes, lost and found items, food truck times, social networking meet-ups, and, Problem Reporting; e.g., plumbing, HVAC, power outages. Types of advertising transmitted to the tenant may include, but are not limited to: coupons, discounts for new tenants, local restaurant specials, dry cleaning, babysitting, theaters nearby, and other local businesses that pay the property manager for the ad space or for tenant-redeemed offers.

The particular architecture of the instant system also makes it an ideal personal health and well being monitoring tool for elderly or disabled persons wishing to maintain maximum independence; e.g., an elderly person choosing to remain in his or her home instead of a residential home or nursing facility. In the foregoing example, the elderly person may wear a smart bracelet device that monitors his or her heart rate, temperature, movement, and senses for falls. When a bracelet or other worn device indicates a fall, the smart hub system will attempt to voice prompt the user to confirm that there was indeed a fall in order to reduce false alarms. In cases where the wearer's body metrics are outside normal ranges as determined by the Peebo Smart Hub Component, the smart hub may first attempt to speak to the wearer to obtain more information. If the user does not respond—or responds inadequately—for example, with slurred speech, the smart hub may take an action such as independently calling an emergency contact or even directly calling 911 in which case the voice controlled AI Peebo assistant may 240 interface verbally or through messaging to a 911 dispatcher,identify itself and give the emergency dispatch operator the information required to respond such as user health metrics obtained from a worn health monitoring device such as a bracelet and the location of the user when the user is unresponsive. In cases where an ambulance is called, the smart hub will maintain contact with the emergency dispatcher and unlock the doors for paramedics to gain entry. The smart hub device interfacing with the location aware smart bracelet device, can direct the emergency personnel to the user's exact location. Moreover, the smart hub will have access to the wearer's health metrics preceding the incident and can provide such information as responsiveness, blood pressure, heart rate, respiration and body temperature by verbal messaging, text messaging or personal file on a file server to paramedics and hospital personnel.

The smart hub provides an entire Healthcare Ecosystem that is capable of interfacing with a number of healthcare related devices such as a blood pressure cuff, heart rate monitoring apparatus, blood sugar testing apparatus, smart weight scales and smart mattresses and pillows that are capable of monitoring individual sleep patterns. Consider the case where a elderly user is required to test his or her blood glucose levels four times a day. The Peebo Smart Hub System can remind the user to take his or her readings or voice prompt the user if he or she misses a submission time. In addition, the smart hub system can obtain the blood glucose level and determine if the levels are within normal limits. In cases where the glucose is outside normal limits, the smart hub system can independently contact a healthcare provider and relay information to—and respond to questions from the healthcare provider. If glucose levels are low, the smart hub system may verbally prompt the user to eat an orange, drink a particular beverage or take another action. If blood glucose levels are critically low and the user is unresponsive the smart hub system can independently contact emergency services.

In some instances, the smart hub system may prompt a user to weigh him or herself daily on a smart scale and retain longitudinal weight data that is shareable with a healthcare provider. In some instances, the smart hub system may at various times of day, prompt a user to exercise on a stationary bicycle or treadmill. In yet other instances, the smart hub system may prompt a user to take his or her medication that is dispensed by a smart pill dispenser, ensuring that the user does not accidentally take excessive medication. The healthcare ecosystem may be set up and administered by the user himself, a home healthcare provider, a nurse, a dietitian, a social worker, a gerontologist or any other party interested in the health and well being of the user.

In the case of a fall, the smart hub system will seek to determine if the monitored user is responsive and able to move. If so, the smart hub system can call the cell phone of an emergency contact and place the responsive user on intercom. If the monitored user is nonresponsive, the smart hub system can contact a 911 emergency dispatcher directly and convey details to the dispatcher such as time of fall, vital signs of the user and residence address.

In some instances, the smart hub system may be configured to call an on demand transportation service such a Lyft or Uber. The smart hub system may call for grocery delivery, call for meal delivery and call tradespeople such as plumbers, electricians and landscapers as needed.

A graphical user interface is provided to add healthcare related devices to the Peebo Smart Hub System. In one example, when a smart stationary bicycle is added, the administrator is asked how often the user is to be prompted to exercise. When the stationary bicycle is operated, at least the start and stop date and time is monitored or recorded. Times to poll whether exercise has taken place are at the discretion of the administrator; e.g., twice daily, end of day, end of week, etc. If the user does not exercise according to a healthcare provider mandated exercise regime, the Smart Hub may be configured to take no action, deliver one or more verbal reminders or report back to the healthcare provider.

Smart Hub System Setup

Setup Procedure

In some exemplary implementations of the smart hub system, a user will connect the smart hub to a WiFi router. If the router has an active internet connection, smart hub system set up may be automatically initiated when the smart hub component is connected to the home/office network. To access smart hub functions, the user is prompted to enter the credentials of his/her home/office network. Once the smart hub is installed and functioning, it will create a peer-to-peer network between the smart hub component and at least one portable computing device such as a smartphone or tablet computing device. Peebo administrative and user software components may be pre-loaded on the tablet if the tablet is sold with the Peebo system, or, the tablet or smartphone may be prompted to download the applicable software components. The tablet running the smart hub system software will recognize the smart hub component and provide a visual interface with device discovery functions, as well as other functionality. During the setup process, a permanent peer-to-peer connection between the tablet and the smart hub component is created. Multiple tablets may then be added to the network. The tablets are location-aware, are geo-locatable, and may communicate with each other directly and to the smart hub component directly. Typically, the smart hub component will receive and relay status/metrics to and from connected home automation devices, and provide the status/metrics through one or more tablet interfaces. Users typically control the home automation devices by accessing the tablet interfaces with the smart hub serving as an intermediary. However, in some cases, such as infrared activation of home automation devices, the tablets can execute a command directly.

Device Discovery

Before home automation devices may be controlled by the smart hub system, the devices must be added to the smart hub network by a process called device discovery. The following setup procedure that includes set up and device discovery is merely exemplary and the steps may be in the sequential order provided, or another order. In cases of home automation devices connected through third party vendor proprietary cloud services, a user will provide the login name, password for the vendor's server. The smart hub component will then download configuration data and discover the devices corresponding to the vendor. Downloading of configuration data may be via an internet connection or any suitable cellular connection protocol. The devices are assigned default icons that may be viewed in the user interface of the one or more tablet computing devices. In the Device and Discovery interface, a user may then assign the default device a unique name and an icon. In addition, a user may assign an audible name or command to correspond with the unique name and icon. Peebo may network third party (subordinate) smart hub devices, such that devices added to the subordinate smart hubs will be discoverable and added to a Peebo master list of devices. The devices are then controllable by a Peebo authorized user and the authorized user may customize the device indicator.

When devices are added and properly discovered, the devices are shown with an default icon in a user interface. The default icon may be clicked on to edit the device indicator by changing the default icon to an icon or simply word or phrase the user finds more descriptive. Further, the device indicator may be clicked on to associate a particular behavior for the device when the device is activated. For example, family room track lights may be set to dim by 25% when the device is active (ON). A discovered device will generally come with a number of functions that may be accessed when an appropriate value is passed to the device. These values and explanations of the associated device behavior(s) are typically contained in the configuration data that accompanies the device or is downloadable from a vendor. Lighting devices tend to have fairly limited functionality e.g., on (dim by %), and off. Other devices such as irrigation systems tend to have a richer behavior set. In any case, along with user icon designation for a particular device as shown in (FIG. 4), other available device behaviors may be raised by a menu (not shown) when the particular device is selected for editing. After the device is edited for behavior, a set of instructions for the device is saved locally. Any device behavior may be programmed to occur regularly by way of a device scheduler (not shown) running in the background. For example, a speaker in a child's room may be scheduled to play a lullaby at a particular time every evening.

Scene Creation

The discovered device(s) may be grouped by a user into a scene (e.g., bedroom, kitchen, garage, game room, home theater). A scene is a user defined grouping of icons wherein the icons represent connected devices and/or other actions or commands. Typically, a scene named “Home Theater” might contain icons enabling control of overhead lights located in the home theater, a sound system, e.g., speakers and receiver, and a projection system. Multiple actions to be performed on the foregoing devices and the particular sequence of action 365 execution may be pre-defined and saved by a user. One such action grouping might be (1) turn on home theater lights and dim at 20%, (2) turn on receiver, (3) set speaker volume at 30%, and (4) turn on Netflix®. Although the foregoing Home Theater example relates to a scene defined by location, scenes may include actions to be taken on devices that are not located in the same room. Accordingly, connected devices may be grouped in a intuitive manner according to user preferences irrespective of location or similar functionality. The following procedure that includes steps for scene creation is merely exemplary and the steps may be in the sequence provided, or another sequence. In order to create a scene as user will (1) name the scene (e.g., “workshop”), (2) optionally assign a voice command to audibly access the scene, (3) drag and drop any networked devices to be added to the scene, (4) specify the action to performed on each device in the scene (e.g., turn of lights 100%, play favorite music playlist or radio station). In addition, an audible announcement may be recorded, saved as an action (e.g., “Dad is in the workshop do not disturb.”), and may be added to the list of actions to perform for a particular active scene. When a user activates a scene, along with the actions to be performed on the assigned devices, an audible notification may be sent to any one or all of the smart hub connected tablets. If for example, the audible notification is to be delivered preferentially to daughter “Suzie,” because the local voice recognition components can differentiate between users, it is possible for one of the tablet components to know Suzie's location and play the notification to her, instead of a whole house broadcast. User-defined actions to be performed regarding the devices assigned to a scene may also be set to occur at a regularly scheduled time.

Tablet Wake Feature

A “wake up word” is a user-defined phrase that connected tablets “hear” that places the tablets in active listening mode to receive voice commands that follow the wake up word. Valid latency times/periods for follow up commands may be adjustable by an authorized user. Connected tablets do not require an active internet connection to respond to the wake up word. Offline voice recognition capability may be provided by a software based engine loaded on the tablets or an embedded speech recognition module (e.g., SpeechFX, TI-05535, etc.). Further, many common words or phrases may function as the wake up word. When sensing a voice command, the tablet nearest the vocalizing user becomes the primary tablet, and other tablets are prevented from duplicating the vocalized command. If two tablets are similarly distanced, one tablet temporarily designated a responding tablet will ask the user to specify which tablet they intend to carry out the command (e.g., Are you talking to the tablet in Susie's room?”). Tablets of the instant system feature a highly sensitive and omni-directional microphone, voice vs non-voice differentiation and speech-to-text translation up to 20 feet away from a vocalizing user. The microphone/detection technology features noise and echo cancellation, sensing of direction (Direction of Arrival) voice tracking, and beamforming. Basic voice identification, i.e., matching a voice command to a particular user does not require an internet connection, and the voice authentication is performed locally on the client. User authorization is also performed locally on the client. In this way, even if the internet connection is down, access to and full control of any connected home automation device is still available to the user. Once the wake up word is detected, voice identification and authorization is performed to determine the status and permissions of the speaker, i.e., if the speaker is authorized, or a guest. If for example, an authorized user commands the system to reduce the temperature to 65 degrees, the system will execute the command. If on the other hand, an unknown speaker commands the system to set the temperature to 65 degrees, the smart hub system will not execute the command. Default guest permissions may be set by the system administrator. For example, a guest may be granted permission to increase the volume of a home theater system, but may lack permission to lock the front door. Core speech-to-text functionality is provided without an internet connection. Users may program a limited set of core voice commands for status and control of any home automation device. For example, a user may define the voice command “Stella, Home Status” where “Stella” is the user defined wake up word for the system, to inform the user of (1) the number of lights ON in the house, (2) HVAC/Thermostat settings, and (3) garage door status (OPEN or CLOSED). One or more commercially available third party embedded, voice recognition platform SDKs or cloud based voice recognition modules may be leveraged to provide enhanced voice recognition features. When the system is augmented with a cloud based application layer, the number of voice commands is practically unlimited, the system's virtual assistant capabilities are greatly enhanced, and the system may leverage the abilities of connected cloud dependent devices and appliances, e.g., Alexa, Sonos or Joule.

Smart Intercom Person Locating and Tracking Functionality Because the tablet components feature user identification by voice analysis, typically by a program that employs Fourier transforms, and the tablets may be set to active listening mode, it is possible for an authorized user to track another user within proximity of the tablets. Specifically, if daughter Suzy requests that the system find her father, the tablets will listen throughout the house and report her father's location in the house to Suzy when her father's voice is identified. Location tracking may be enabled on an individual basis. For example, parents of children may have their personal tracking disabled, but enable the location tracking function for their children. Voices not recognized as a registered user could be logged and a notification generated.

Application Architecture

Client Layer

Exemplary implementations of a client interface may include a high level communication module that transmits and receives client-to-cloud and client-to-client communications. However, all core functionality relating to connected devices such as tablet computing devices or connected home automation devices is available offline. In cases of ISP failure, the connected home automation devices will continue to work. The client layer has at least a voice recognition module with speech-to-text capabilities, a core protocols module for recording configuration and operation variables for connected home automation devices and a stored command data layer that links devices to user-defined actions. The stored command data layer may include user-scheduled times and dates for device or scene actions and may access the smart hub system date and time to execute regularly scheduled actions. Other non-core functionality such as VOIP, and portal access to web/cloud based services (e.g. Netflix®), requires an internet connection. In some exemplary implementations the smart hub component may include an internal WiFi router. In other implementations the smart hub component may come with its own CISC chip, a RISC chip and an operating system. The screens, panes and visual interfaces for creating scenes, assigning devices to scenes and customizing the user interface(s) are available on any local client and do not rely on cloud based dependencies. Further, the instant invention provides the ability to limit or shut off internet access from specified devices. For example, internet access might be limited to allow only speech-to-text interpretation. Limitations could be enabled by voice command, a set schedule or a touch screen button.

Cloud Based Application Layer

While functionality such as GPS is available through a cellular network, other non-core functionality of the system such as accessing Netflix® service or accessing some functions of connected but cloud based devices such as Sonos® relies on an active internet connection. Applications such as storing backup data, backup of device configurations, enhanced voice recognition and advanced intelligent assistant capabilities typically require a cloud-based application layer. Features objects and aspects of the cloud based application layer may leverage third party services, e.g., a voice recognition API, SDK, etc. to augment basic client based functionality.

Data Storage Layer

A core protocols module, and a stored command data module exist with the local client so that core functionality is not compromised by ISP failure and the like. The core protocols module may include home automation device attributes data. An encrypted cloud-based data storage layer may provide backup and augmentation of core capabilities. Regarding data storage and retrieval, either client based or cloud based, any known associative data scheme may be employed to provide the functionality of the smart hub system in accordance with aspects set forth herein. Communication protocols for client-cloud or client-server communications such as SOAP and REST are well known. The smart hub system data layer may include one or more relational databases, which may contain objects and/or references to objects such as documents, notification/alert objects etc. Databases suitable for practicing aspects of the present invention may be, but are not limited to: PostgreSQL, MySQL™, Oracle®, SQL Server, Cassandra™, Riak, Redis, and document-oriented databases such as BaseX, Cloudant and MongoDB. Backup data in a cloud environment may include any data structure or relational database; whether typical SQL based or NoSQL (aka not only SQL″) or, any data model that will suggest itself to those having skill in the art and benefit of this disclosure. In the implementations described herein, some actions taken on the local application relating to non-core functionality may be matched with corresponding changes in a cloud environment by customary means including asynchronous or synchronous communication using known communications protocols between the local application and one or more servers in a cloud based environment.

Default VPN Connectivity

Applicant is not aware of any other smart hub system that provides out of the box VPN connectivity such that all LAN connected devices are shielded from malicious intrusion practices such as packet and port sniffing. The VPN ensures that user internet activity is not traceable to its source, and greatly enhances security against cyber attacks and hacking attempts. Further, the instant smart hub system allows for a VPN connection between a user's remote mobile device and the system's VPN to enable remote monitoring of a property. All devices (tablets, smartphones, etc.) configured to use the system VPN in the home or other property will automatically be configured to use the VPN for activities outside the networked property. The instant system permits a user to temporarily bypass the VPN if required.

System Integrity Engine (SIE) with AI Summary

The SIE provides device metrics using AI and includes a status page on all tablet computing components, usage data logs and user notifications. The SIE (1) receives data from device sensors that includes, but is not limited to: indoor and outdoor temperature, motion, water, smoke, carbon monoxide, fire, air quality, light, weather, etc., (2) confirms user command execution according to user notification preferences (i.e., audible message to tablets, email, text message, or tablet interface), (3) regularly scans network and WiFi to monitor wireless 505 and wired clients, (4) detects, logs and reports intermittent and critical device failures, (5) pings all connected devices regularly, scans for anomalies and (6) performs speed tests for each tablet computing component. Further, the SIE encompasses a set of External Network (WAN) Automated Tools which autonomously runs bandwidth tests at default or user selected intervals, logs connectivity or speed issues for AI analysis, notifies a user of ISP performance according to user notification preferences (i.e., audible or text, email, text message, or tablet interface). Through the foregoing active measures, the SIE analyzes data to detect any suspicious or anomalous activities and notifies the user and system support staff for corrective action. The smart hub system of the instant invention includes a local instance of the SIE that permits certain core level functions such as monitoring sensors offline, logging and reporting on ISP outages, and reporting service slow downs. However, the SIE may leverage cloud based analytic tools to enhance its capabilities.

### BRIEF DESCRIPTION OF THE DRAWINGS

FIG. 1 is a diagrammatic view of an exemplary smart hub system according to the current invention described in this disclosure;

FIG. 2A is a diagrammatic view of an exemplary smart hub configuration showing multiple home automation eco-systems;

FIG. 2B is a continuation of the diagram of (FIG. 2A) showing a cloud application layer 240;

FIG. 2C is a diagram showing voice-to-text and text-to-voice interaction between multiple users.

FIG. 3A shows a typical device discovery interface;

FIG. 3B is an exemplary view of a home screen interface with multiple panes for user management of various discovered and added home automation devices, and local and cloud based service access;

FIG. 4 is an exemplary view of a device indicator creation interface for building a home screen;

FIG. 5 is an exemplary view of a scene action creation interface for creating scenes to be added to the a home screen;

FIG. 6 is an exemplary view of an icon creator and icon preview screen for scenes;

FIG. 7 is a diagrammatic view showing an exemplary implementation illustrating a relationship between the System Integrity Engine, a VPN connection and a cloud based application layer that handles notifications of system status changes;

FIG. 8 shows an exemplary system monitoring status interface showing metrics derived from the System Integrity Engine with AI Summary that reports status over time for the WAN 535 and LAN connections, as well as sensor data and user alerts;

FIG. 9 is an example of prior art for purposes of comparison, by HomeSeer®, which includes an interface to an IFTTT webservice requiring at least basic programming expertise;

FIG. 10 is an exemplary view of a home screen interface with multiple panes for user management of various home automation devices, including personal health devices, and local and cloud based service access.

### REFERENCE ELEMENT LISTING

100 system

200 Peebo smart hub component

201 Device Ecosystem

530 201a, 201b Home Automation Device

201c sensor devices

202 client layer

204 voice recognition module

205 core operation protocols

206 voice authentication

208 voice identification module

210 voice authorization module

212 voice command module

218 system integrity engine

220 sensor monitoring module

222 command confirmation module

224 LAN automated monitoring module

226 WAN automated monitoring module

227 modem

228 VPN

230 router

232 cloud

233 secure network

240 cloud applications layer

241 cloud data module

242 enhanced voice recognition module

244 VOIP module

246 enhanced virtual assistant module

248 third party applications

555 250 System Integrity Notification Module

300a, 300b Peebo tablet component/user supplied mobile device

302 microphone

304 speaker

306 home screen interface

308 animated virtual assistant pane

309 customizable avatar

310 scenes pane

312 room tabs

314 device icons with status indicator

315 high—low adjustment control

316 view style control

318 sort by control

320 device indicator creation interface

321 device indicator preview

322 device indicator button type selector control

324 device indicator button style selector control

326 voice command recording

327 device label assignment control

328 microphone

329 icon

330 icon library

332 icon import control

333 camera control

334 keyboard input control

336 scene action creation interface

338 scene drag and drop pane

340 lighting action assignment control

342 saved scenes pane

344 scene voice command assignment control

346 scene label assignment control

347 microphone control

348 scene icon assignment interface

350 scene preview pane

352 scene indicator button type selector control

354 scene indicator button style selector control

355 icon library

360 system monitoring status interface

361 system integrity notification module

362 WAN status pane

364 LAN status pane

366 VPN status pane

367 Update Peebo Devices Pane

367a Update Peebo Devices Control

368 sensor status pane

370 alerts pane

380 rules input interface

390 privacy filter

Definitions

In the following description, the term “Smart Hub System” or “Peebo smart hub system” may be used interchangeably and, as the term(s) are used herein, refers to a network (LAN) connectable hub that is capable of integrating the functionality of multiple devices, that include home automation devices, also termed the “internet of things.” In this application, the term “home automation devices” is intended to encompass various networked sensors and personal healthcare devices. The system also includes one or more portable computing devices such as a smartphone, or more preferably a tablet computing device that communicate with the smart hub and with each other. The term “portable computing device” or “portable computing component” means a computing device with video display capability such as a smart phone device, tablet computing device e.g., iPhone iPod®, Android, etc. “Tablet computing device” or “tablet component” refers to a smart tablet with some features and functions that may be accessed independently of an internet connection, and which at least includes a microphone, a speaker, and one or more software components providing functionality according to the present disclosure. The term “local” means computing primarily executed by local device computing resources. The term “wired” as used herein, refers to cabling of any system capable of carrying a digital signal. The term “wireless” may refer to a wireless telephony method such as GSM, CDMA, a WiFi signal transmitted by a WiFi transceiver local to components of the instant system, or, a Bluetooth® signal. In cases of a WiFi signal, the signal may be a wireless ad hoc network (WANET), or a WiFi hotspot utilizing a conventional WiFi router. The term “smart” when used to describe a device, means the device may be interfaced in some manner with the Smart Hub System and at least some working data obtainable from the device, e.g., through a device API that may be interfaced with third party AI. Typically, this indicates the device is wired or wireless enabled either through Wifi, Bluetooth® or the like. The term “subject” refers to a user who is the subject of monitoring to differentiate from another user such as a care giver who is not the subject of monitoring. Users may be subjects and subjects may be users depending on the context. Unless otherwise explained, any technical terms used herein have the 630 same meaning as commonly understood by one of ordinary skill in the art to which this disclosure belongs. The singular terms “a”, “an”, and “the” include plural referents unless the context clearly indicates otherwise. Similarly, the word “or” is intended to include “and” unless the context clearly indicates otherwise. Although methods and materials similar or equivalent to those described herein can be used in the practice or testing of this disclosure, suitable methods and materials are described below. The term “comprises” means “includes.” All publications, patent applications, patents, and other references listed in this disclosure are incorporated by reference in their entirety for all purposes. In case of conflict, the present specification, including explanations of terms, will control. In addition, the materials, methods, and examples are illustrative only and not intended to be limiting.

### DETAILED DESCRIPTION OF THE EMBODIMENTS

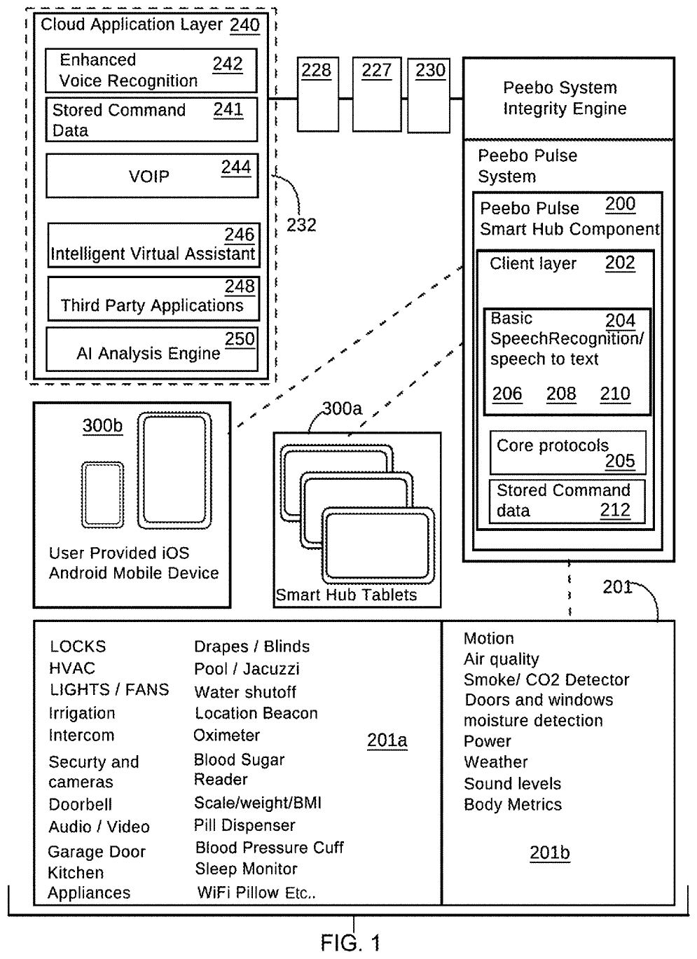

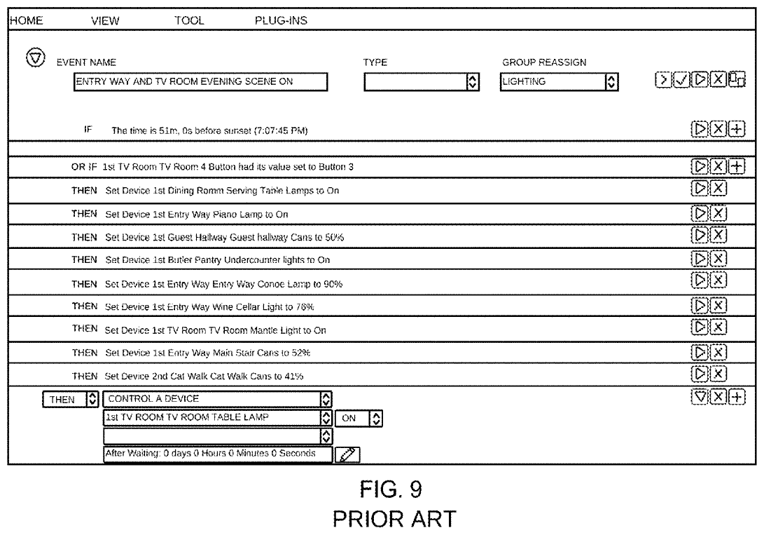

Referring generally to FIGS. 1-10, a smart hub system 100 is configured to provide core functionality for connected devices, some of which are home automation devices, in case of internet connection failure and includes local voice recognition capability, local voice authentication capability, local voice identification capability and local voice (user) authorization capability. Typically, the smart hub system is configured to access the internet to provide enhanced capabilities, but even in the absence of an internet connection, connected devices will continue to function. Typically the system includes a hub component 200 that is connected to a WiFi router 230 and offers automatic VPN 228 connectivity wherein the VPN service is provided and maintained by the vendor of the smart hub system. VPN service means an VPN client slide application connecting securely with a VPN server. In some implementations the smart hub component 200 and router component 230 may be physically combined. The smart hub of the instant invention is configured to connect to multiple portable computing devices such as smartphones 300b or preferably, tablet computing devices 300a so that a communications interface may be established to monitor and control various networked devices, some of which may be home automation type devices and others being sensors and personal healthcare devices.

The smart hub device includes at least a microcontroller with a processor capable of running software, a WiFi module, a telephony module, a microphone and a speaker. The tablets 300a expose several graphical user interfaces (306, 320, 336, 348 and 360) that enable an authorized user with sufficient permissions to connect multiple home automation devices (201a, 201b) to the network, properly discover the devices, download and store relevant configuration data, and set up interactive environments that include devices and scenes 309 which comprise one or more device eco-systems (201). One or more device behaviors may be programmed to take place within a scene when the scene is active. A user may associate an icon from an icon library 330 to represent a device or a scene. Using a microphone 347 of the tablet component 300a, a user may record a voice command that activates a device or scene when the voice command is spoken. A device or scene may be respectively labeled with the device label assignment control 328, or the scene label device control 348.

FIG. 1 is a diagrammatic view of an exemplary configuration of a smart hub system 100 in accordance with the present invention. Smart hub component 200 also termed “Peebo Pulse” provides out of the box VPN connectivity 228 to any active internet connection. In the particular implementation shown, the smart hub component 200 includes a local system integrity engine (SIE) 218 which collects operational data from networked devices, a client applications layer 202 which includes a speech recognition module 204 comprising a voice authentication module 206, a voice identification module 208 and a voice authorization module 210. The client applications layer also includes a core protocols module 205 and a stored voice command data module 212. The smart hub wirelessly connects to a number of home automation devices 201a, 201b sensors 201c, and one or more portable computing devices (300a, 300b). While core functionality to all connected devices is ensured by the local application layer, the system includes a cloud application layer 240 which provides an enhanced voice recognition module 242, cloud stored command data 241, a VOIP module, intelligent personal assistant 246, an AI analysis engine 250 which prompts a smart hub response which may be an unsolicited voice prompt based on reconciliation of user inputted rules and user behavioral patterns and may include one or more third party applications 248 or modules. An exemplary listing of connectable devices 201a and sensors 201b is shown at the bottom of the diagram.

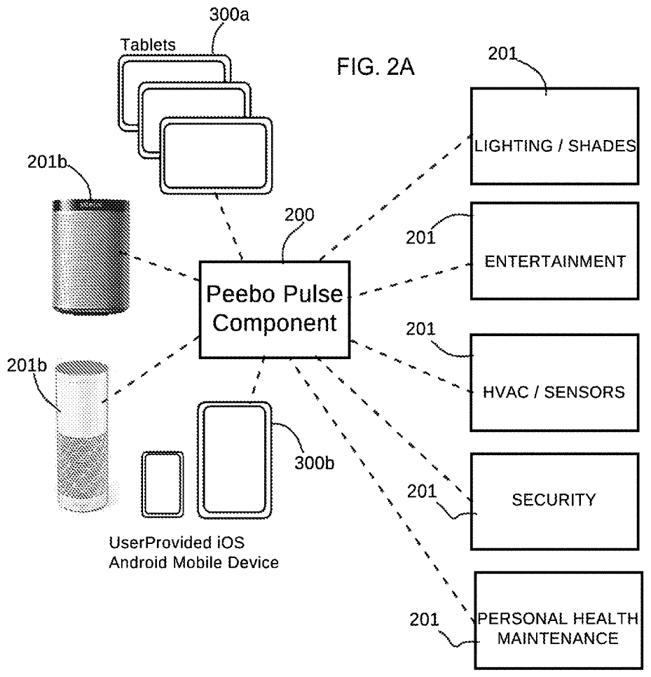

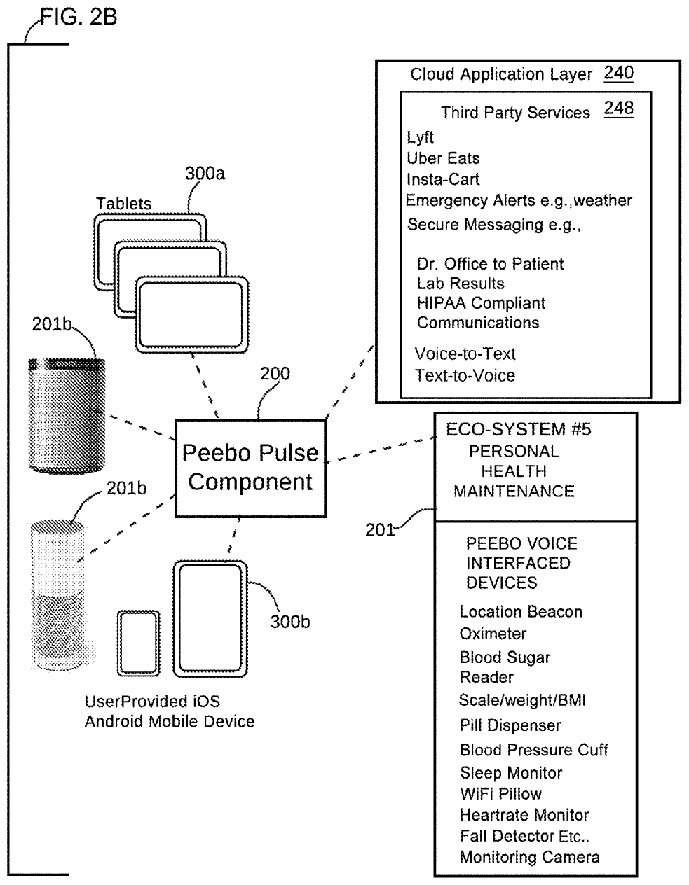

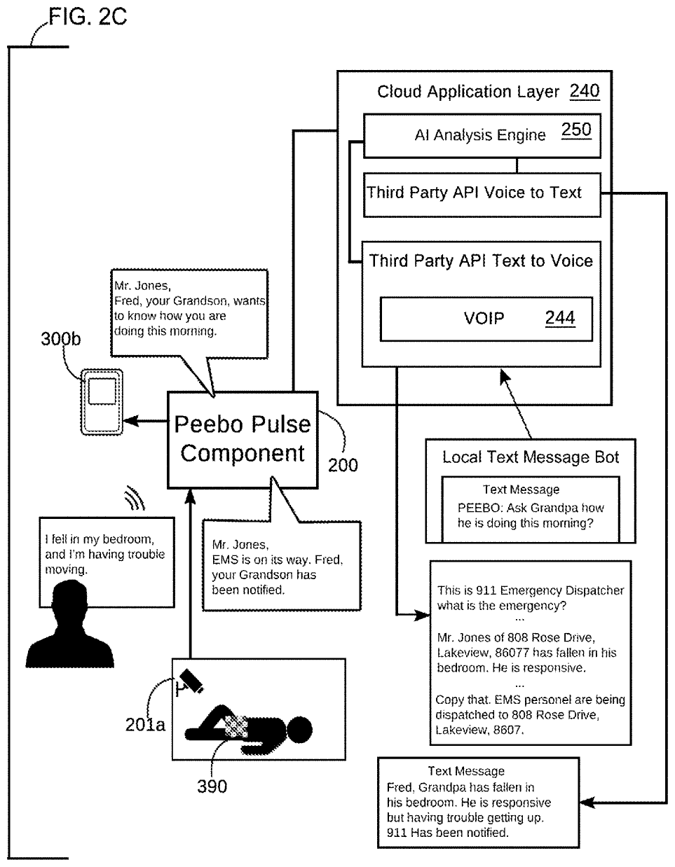

FIG. 2A is a diagrammatic view showing various eco-systems (e.g., lighting and shades, entertainment, climate control and security) that may be connected to the Peebo System. Additionally, the Amazon Echo which connects to the voice controlled intelligent personal 690 assistant service Alexa, and the Sonos are supported devices.

FIG. 2B is a diagrammatic view that shows more detail for the healthcare eco-system which enables the networking of multiple personal smart healthcare devices such as blood glucose monitoring devices, blood pressure cuffs, weight scales and exercise devices. The smart hub system records subject healthcare data, and works to recognize subject life patterns such as sleep and wake times. From the accumulated data—some of which is directly obtained by the devices and sensors, and some of which is inputted by the subject or an authorized person such as a family member or personal physician, a routine is established by analysis of the data by a custom or third party AI API. Some data includes rules such as acceptable and unacceptable deviations from normal physiological readings. The system includes a simple rules based input interface that allows an authorized person to set baselines for physiological readings that are considered the norm and which reside outside the norm. For example, in some cases, moderately high blood pressure may not trigger a response from the system. In other cases where the subject is taking blood pressure medication, moderately high readings would trigger a response from the system that may be a voice notification made to the subject, or, a text notification sent to the subject's personal healthcare provider. It should be understood that the smart hub system may make unsolicited prompts to notify the subject of a scheduled appointment, a change in blood glucose levels and other information entirely without the subject's solicitation.

FIG. 2C is a diagram showing voice-to-text and text-to-voice interaction between multiple users. In the example interaction, the relative (Fred) initiates a call to Peebo VOIP number to check on his grandfather. A smartphone SMS recognizes the lead word “Peebo,” and routes the call to the intelligent assistant. The smart hub assistant asks Mr. Jones how he is fairing. As it happens, Fred's grandfather (Mr. Jones) has fallen in his bedroom and was not wearing a motion detection device. Mr. Jones verbally notifies the smart hub system that he can't seem to move. In response to this information, the smart hub device notifies 911, activates a camera 201a in Mr. Jones's bedroom, notifies Mr. Jones that emergency personnel are being dispatched, notifies Fred by text about the situation, and makes a live camera feed available to authorized persons via their smart phones 300b. The smart hub system includes a real time privacy filter 390 for camera monitoring functions that will blur areas of the body that a subject does not wish to be exposed. In another scenario (not pictured) Fred texts: “Peebo, tell Grandpa I'm coming over in a few minutes.” Locally, the intelligent assistant informs verbally or by text that “Fred said he is coming over in a few minutes.” and “You need to get ready.” When Fred arrives, he texts “ Peebo, tell Grandpa I'm here.” The intelligent assistant then asks Grandpa whether he would like to open the front door. If Grandpa responds in the affirmative, the intelligent sends the code to unlock the door. In emergency situations, the intelligent assistant can open the door to emergency personnel and direct them via voice or text to the location of an injured/immobilized subject.

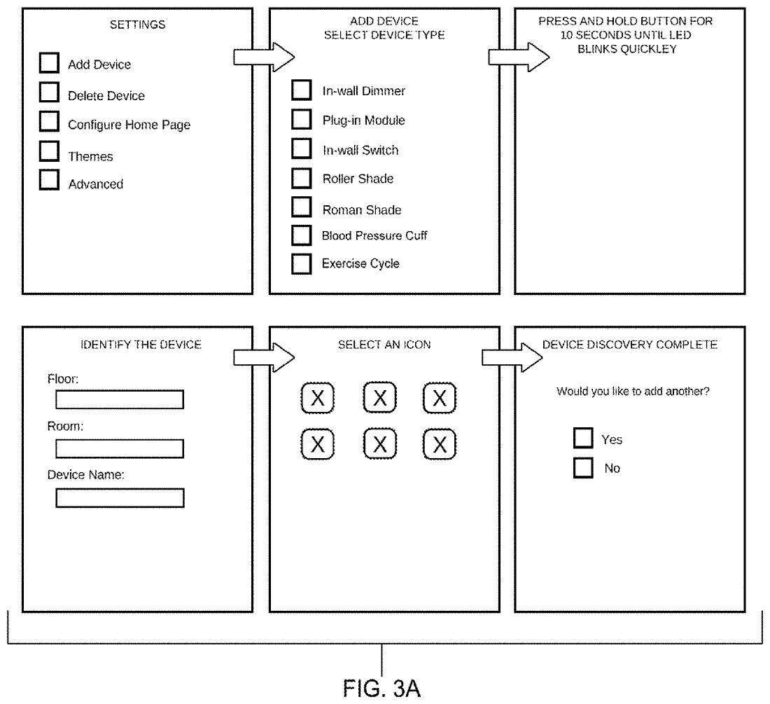

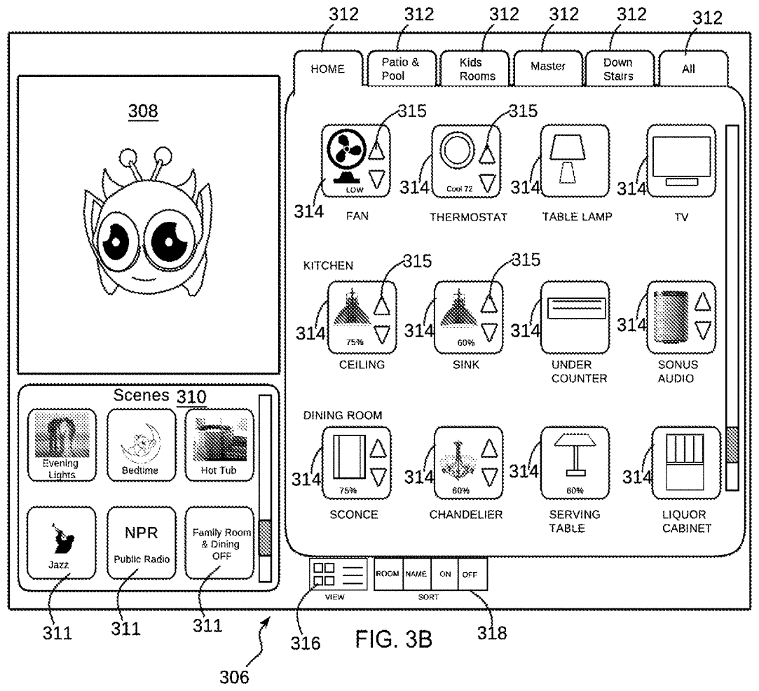

FIG. 3A shows a typical device discovery interface that enables the discovery of various wireless enabled smart devices and their addition to the smart hub network. The interface includes location information (e.g., floor and room) that will be linked to the device name in subsequent application interfaces.

FIG. 3B is an exemplary view of a home screen interface 306 that permits user control of various home automation devices as indicated by the icons 314 and high/low controls. In the particular implementation shown, tabs 312 correspond to rooms in an home. An intelligent assistant 308 “Peebo” is shown in the upper left pane. The Peebo assistant represents the default assistant and avatar for the smart hub system. As with other system functionality, while the intelligent assistant 308 is available without an internet connection and is capable of responding to voice command relating to core functions of the system, abilities of the intelligent assistant are greatly enhanced by an active internet connection, and cloud application layer 240. Saved scenes are shown in the bottom left pane 310. By clicking on one the saved scenes, e.g.,“Evening Lights”, “Bedtime”, “Hot Tub”, etc., actions and behaviors associated with the selected scene will be executed. A scene may also be activated by an authorized user vocalizing a voice command, if any, previously associated with the scene.

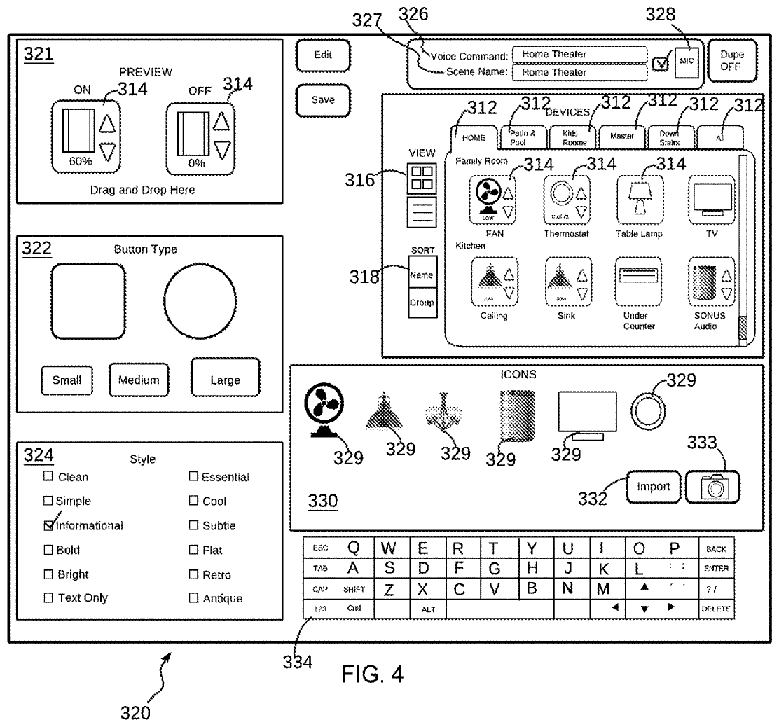

FIG. 4 is an exemplary view of a device control creation interface 320. An authorized user may associate a discovered device with a custom icon that the user has imported 332, a photo taken by a camera 333 of the tablet device 300a, or, any one of the stock icons 329 supplied with the instant system and thereby create a device control with control functions. Typically, with some devices such as lights, the device control includes high and low controls which corresponds to the dimming level. Initially a discovered device (201a, 201b) is provided with a simple default text, (e.g., “bedroom sconce”). In order to associate a particular icon 329 to the device, the default control is dragged into the upper right preview pane. According to the devices function and configuration, appropriate controls are automatically added to the control. Preferences for control button type selected in pane 322, and control button style selected in pane 324 will be reflected in the preview pane. Any icon dragged from the icon library 330 and dropped over the device control will replace the default text. The user may save the customized device control, or continue the editing process. A voice command 326 may be assigned to the particular device by pressing mic 327 and recording, and, a label may be applied to the device ind control inputting the desired text 328. To the right of the voice command and device text boxes is checkbox, that when checked will constrain the textual label to the speech-to-text translation of the voice command.

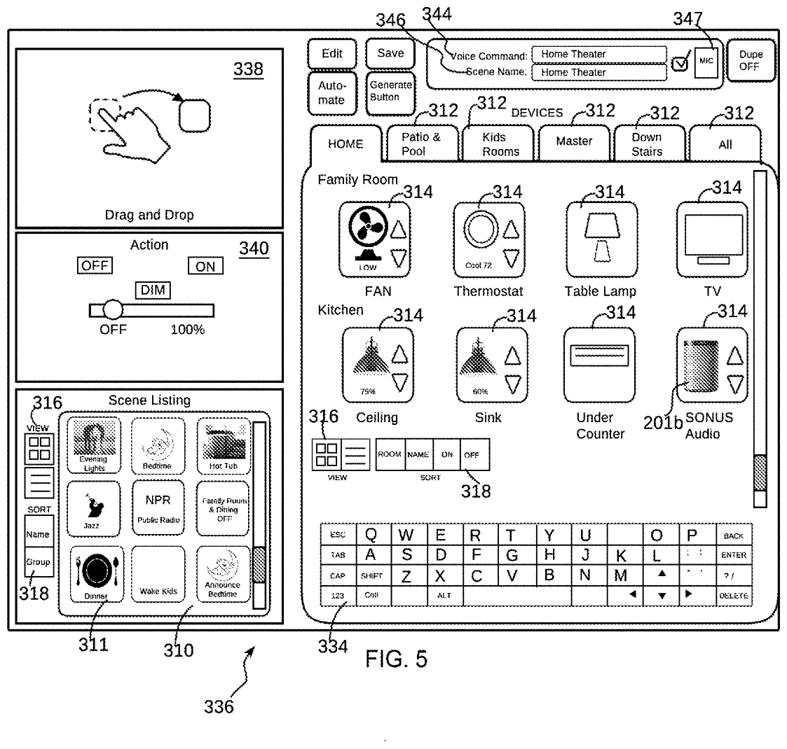

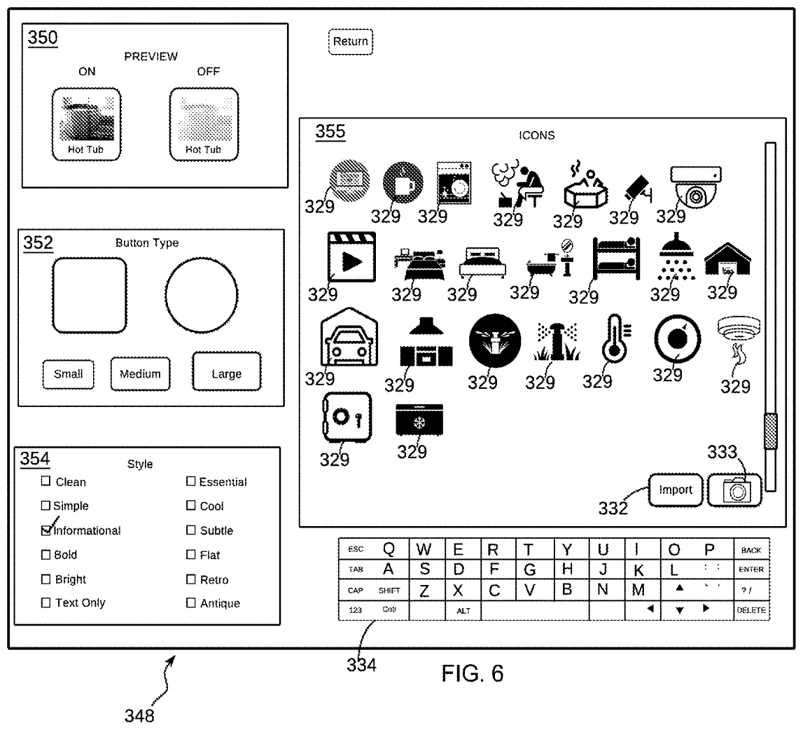

FIG. 5 is an exemplary view of a scene action creation interface 336. In order to create a new scene, a user selects the “Generate Button” which raises the scene icon assignment interface 348 (FIG. 6). The scene icon assignment interface 348 includes a preview pane 350, a scene indicator button type selector control 352, and scene indicator button style selector control 354. The “Return” button raises the scene action creation interface 336. The button/icon assigned in the scene icon assignment interface may be dragged into the drag and drop window for further editing. Once the desired scene appearance and operation is reached, the scene indicator may be saved and will automatically be added to the Scene List 310.

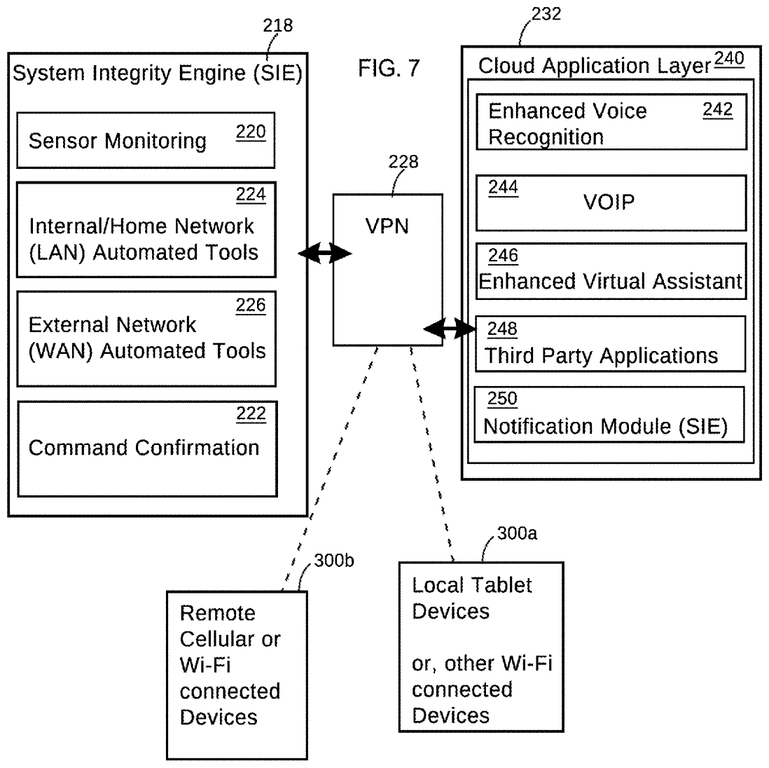

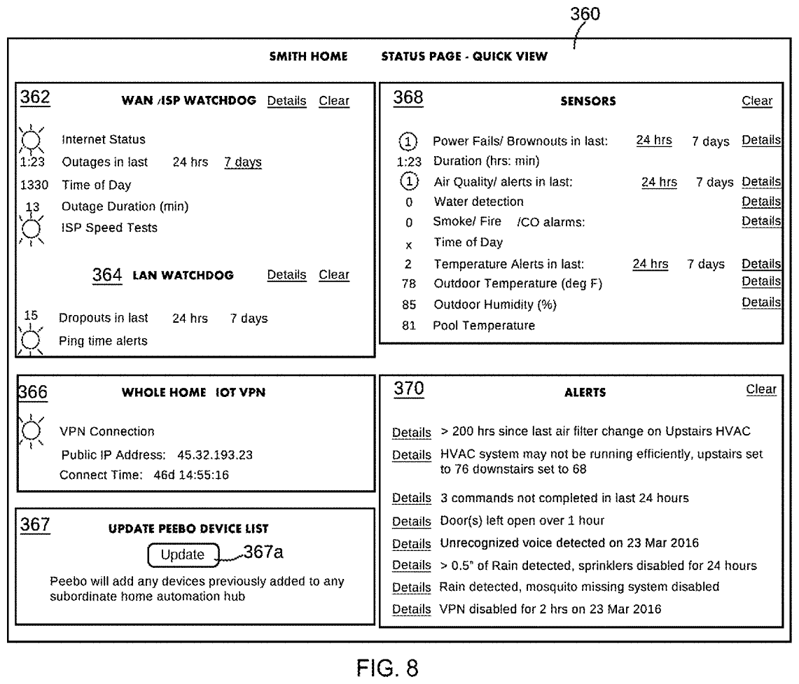

FIG. 7 is a diagrammatic view showing an exemplary implementation illustrating a relationship between the System Integrity Engine (SIE), a VPN connection and a cloud based application layer leveraged by the instant invention. It should be understood that the system integrity engine comprises a local module that collects and polls operational data on networked devices and a cloud based SIE Notification Module that populates the system monitoring status interface (FIG. 8) with relevant data. Double arrows and dashed lines represent two-way communications.

FIG. 8 is an exemplary system monitoring status interface 360 showing metrics derived from the System Integrity Engine with AI Summary that reports systems status over time for the WAN and LAN connections, as well as sensor data and user alerts. Applicant is not aware of any other smart hub system possessing the systems toolset as shown. When a user touches a “Details” control, further information is available. A user may simply use the default tablet notification means, or may indicate another means of notification such as email, text message or audible notification over a tablet device. The status monitoring interface also has a control 367a that enables a user to update the Peebo master list of devices. If a device has been added to a subordinate hub such as the Lutron Caseta Smart Bridge, the Peebo system will find and add the device to the Peebo networked devices and enable a user to customize the new device and add the new device to a scene, etc.

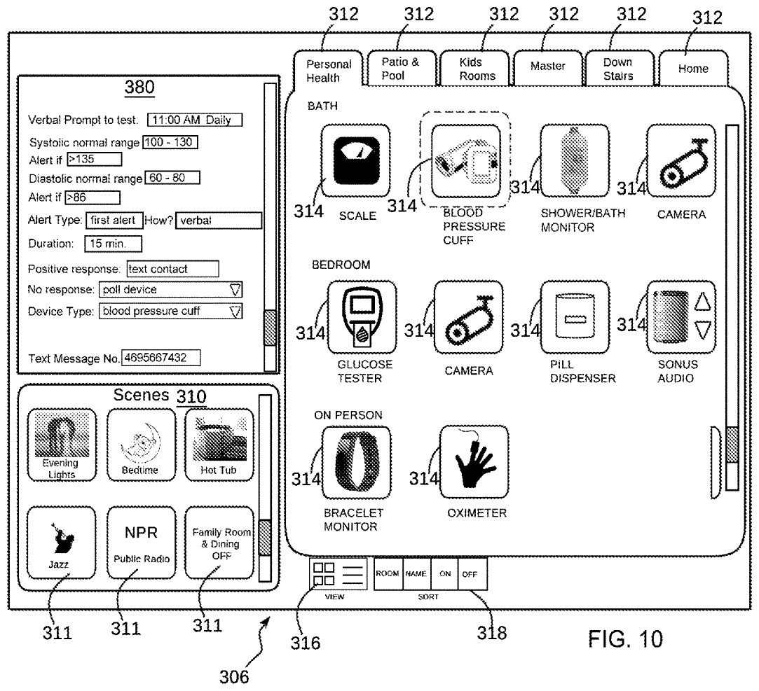

FIG. 10 shows an exemplary graphical interface in accordance with various embodiments of the present invention that shows various networked personal healthcare devices and their location. A rules input interface 380 in the upper left corner permits an authorized user to input various acceptable and alert level ranges for a particular subject. In the example shown, the smart blood pressure cuff is selected. The data obtained from the rules input interface is combined with longitudinal blood pressure data and subject behavior (as obtained by observation and other test results/device readings) by the cloud based AI analysis engine to provide a response which can range from a simple text or voice reminder to observe a daily exercise regime, a warning, a text or voice call to an authorized user, a text or voice call to emergency services. Other possible gauged responses will be appreciated by those having skill in the art and access to this disclosure.

It should be understood that the drawings and detailed description herein are to be regarded in an illustrative rather than a restrictive manner, and are not intended to be limiting to the particular forms and examples disclosed. Accordingly, it is intended that this disclosure encompass any further modifications, changes, rearrangements, substitutions, alternatives, design choices, and embodiments as would be appreciated by those of ordinary skill in the art having benefit of this disclosure, and falling within the spirit and scope of the following claims.

What is claimed is:

1. A smart hub system comprising:
a cloud based AI analysis engine;
a smart hub hardware device comprising:
at least one microcontroller;
a software component that includes speech-to-text output;
a WiFi module;
a digital telephony module;
a microphone;
a speaker;
a smart hub instigated voice prompt function responsive to behavior patterns of a subject and rules data as interpreted by the AI analysis engine;
a graphical user interface including at least one rules input interface;
a device discovery interface configured to add devices to a network managed by the smart hub system; and,
a default VPN WiFi connection.

2. The smart hub system according to claim 1 further comprising a router component.

3. The smart hub system according to claim 1 including a modem component.

4. The smart hub system according to claim 1 including a command and control center for the networked connected devices.

5. The smart hub system according to claim 1 including at least one visual interface to add, maintain and control devices added to a network.

6. The smart hub system according to claim 1 further comprising voice authentication and authorization of users.

7. The smart hub system according to claim 1 further comprising voice identification and tracking of users.

8. The smart hub system according to claim 1 further comprising at least one user created wake up word.

9. The smart hub system according to claim 1 wherein the at least one visual interface includes drag and drop icon and button creation for devices, scenes and automation.

10. The smart hub system according to claim 1 further comprising secure transmission of user behavioral data to the AI analysis engine.

11. The smart hub system according to claim 1 further comprising an interface to monitor subject behavior and to communicate with an authorized user via audio or text messaging.

12. The smart hub system according to claim 1 wherein video monitoring and display includes a real time privacy filter.
